(19) United States
(12) Patent Application Publication
(10) Pub. No.: US 2009/0298519 A1
(43) Pub. Date: Dec. 3, 2009

(54) SYSTEMS, METHODS AND SOFTWARE APPLICATIONS FOR MOBILE DEVICE MENU MODIFICATION

(76) Inventors: Adrian Chan, Cupertino, CA (US); Thyagarajapuram S. Ramakrishnan, Saratoga, CA (US); David Barnes Still, JR., Menlo Park, CA (US)

Correspondence Address: CARR & FERRELL LLP, 2200 GENG ROAD, PALO ALTO, CA, 94303, US

(21) Appl. No.: 12/475,447

(22) Filed: May 29, 2009

Related U.S. Application Data
(60) Provisional application No. 61/130,392, filed on May 29, 2008.

(51) Int. Cl. H04W 4/12

(52) U.S. Cl. 455/466

(57) ABSTRACT

Embodiments of the present invention provide systems, methods and software applications for mobile device menu modification. In an exemplary embodiment, a menu modification module may add a menu selection to a mobile device contact application user interface for selecting a recipient to receive a bubble message. In some embodiments, a character or character set is prepended to a recipient's telephone number for purposes of utilizing a telecom service to contact a bubble server. In another embodiment, a bubble server telephone number is used to route a recipient's telephone number to a bubble server. In various embodiments, after the bubble server is contacted, DTMF tones of the recipient's telephone number may be sent to the bubble server.

### CROSS-REFERENCE TO RELATED APPLICATIONS

The present application claims the benefit and priority of U.S. Provisional Patent Application Ser. No. 61/130,392 filed on May 29, 2008 entitled “System, Method and Software Application for Mobile Device Menu Modification,” which is hereby incorporated by reference.

### BACKGROUND OF THE INVENTION

1. Field of the Invention

The present invention relates to mobile device communications, and more particularly to systems, methods and software applications for mobile device menu modification.

2. Description of the Related Art

Mobile communication protocols include text messaging, such as Short Message Service (SMS), and voice messaging, such as Short Voice Message Service (SVMS). SMS is a telecommunication service allowing mobile device users to send and receive text messages. SVMS is a telecommunication service allowing mobile device users to send and receive voice recordings.

Traditionally, SMS users subscribe to a cellular telephone provider. SMS users typically include many abbreviations to keep a message short. SMS thus provides a “type and read” text messaging environment. Such an environment lacks many attributes that are required for satisfactory communication between parties. Yet, the implementation of better communication systems has been hampered by the failure of mobile devices to readily integrate additional applications outside of those installed on the mobile device at the time of sale. Thus, there is a need for systems, methods and applications for mobile device menu modification.

### SUMMARY OF THE CLAIMED INVENTION

Embodiments of the present invention provide systems, methods and software applications for mobile device menu modification. In an exemplary embodiment, a menu modification module may add a menu selection to a mobile device contact application user interface for selecting a recipient to receive a bubble message.

In some embodiments, a character or character set is prepended to a recipient's telephone number for purposes of utilizing a telecom service to contact a bubble server. In another embodiment, a bubble server telephone number is used to route a recipient's telephone number to a bubble server. In various embodiments, after the bubble server is contacted, DTMF tones of the recipient's telephone number may be sent to the bubble server.

In further embodiments, the bubble message may be a voice SMS message. In other embodiments, the bubble message may be a) a voice SMS message followed by multimedia content selected from the bubble server, b) a voice SMS message with multi-media content combined to play in the background of the voice SMS message upon delivery, c) a voice SMS with special voice effects selected from the bubble server, and/or d) a bubble video SMS message.

Additional embodiments may include a computer readable storage medium having embodied thereon a program being executable by a processor to perform a method for mobile device menu modification and/or utilization.

### BRIEF DESCRIPTION OF THE DRAWINGS

FIG. 1 shows an exemplary system for distributing content between mobile devices.

FIG. 2 is a block diagram of a mobile environment showing a mobile device configured with exemplary modules of an application for mobile device menu modification.

FIG. 3 is a block diagram of a mobile environment showing an exemplary modified menu of a contact application on a mobile device.

FIG. 4 is a flow chart illustrating an exemplary method for using a modified menu for selecting a recipient from a contact application to receive a bubble message via a bubble server.

FIG. 5 is a block diagram of an exemplary computing device.

### DETAILED DESCRIPTION

Provided herein are exemplary systems, methods and applications for mobile device menu modification. According to one exemplary embodiment, a user of a mobile device may readily integrate a software application within an existing mobile device to facilitate a novel voice messaging service (“bubble messages”) between the user and numerous other mobile device users.

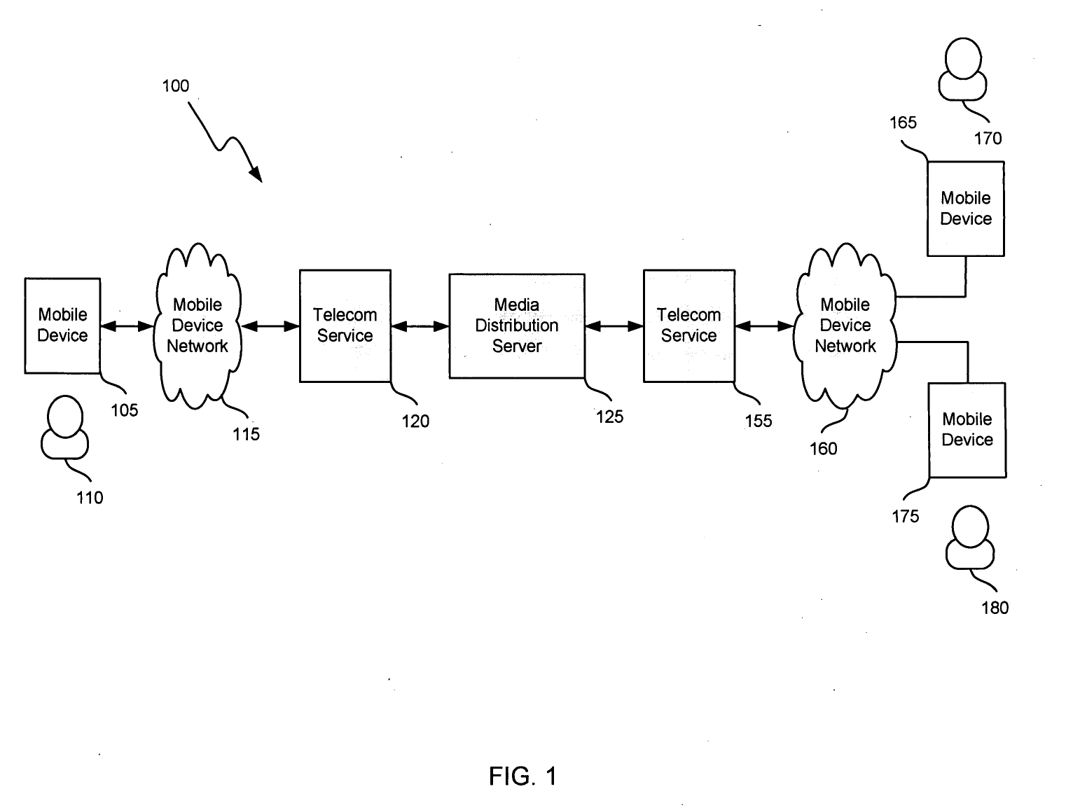

FIG. 1 shows an exemplary system 100 for distributing content (including bubble messages) between mobile devices. The system 100 of FIG. 1 includes mobile devices 105, 165 and 175, mobile device networks 115 and 160, telecom services 120 and 155, and media distribution server (aka “bubble server”) 125. Mobile device 105 may be any computing device capable of connecting to mobile device network 115 and able to transmit audio, video, images, and other media over the network. In some embodiments, the audio may include a voice message created by an author or user 110 that uses mobile device 105. Mobile device 105 may be implemented as a cell phone, personal digital assistant (PDA), a smart phone, lap top computer, or other computing device.

Mobile device network 115 may facilitate communication between mobile device 105 and telecom service 120. The network 115 may be configured to communicate mobile device data, media data including audio data, and other data between mobile device 105 and telecom service 120. Network 115 may include a cell phone tower, relay, switch, server, and other equipment for communications between mobile device 105 and telecom service 120.

Telecom service 120 may be provided by a telecom company and/or a wireless carrier. Telecom service 120 may receive connection requests and other data from mobile device 105 (over mobile device network 115) and establish connections with a recipient of a communication request, such as media distribution center 125. Telecom service 120 may therefore act as a switch in establishing connections between a mobile device 105 and other devices. Telecom service 120 may be provided by telecom companies that provide a telecom service, such as Vodaphone in Egypt, KDDI in Japan, and Verizon in the United States.

Media distribution server 125 may include one or more servers that provide a media distribution service. Media distribution server 125 may receive connection requests and messages from telecom service 120 and relay information, data, media and other data to mobile devices 105, 165 and 175 through telecom service 155.

Telecom service 155 and mobile device network 160 may be implemented in a similar manner as telecom service 120 and mobile device network 115, respectively, but by different providers. Mobile device 165 and mobile device 175 may be associated with subscribers 170 and 180, respectively.

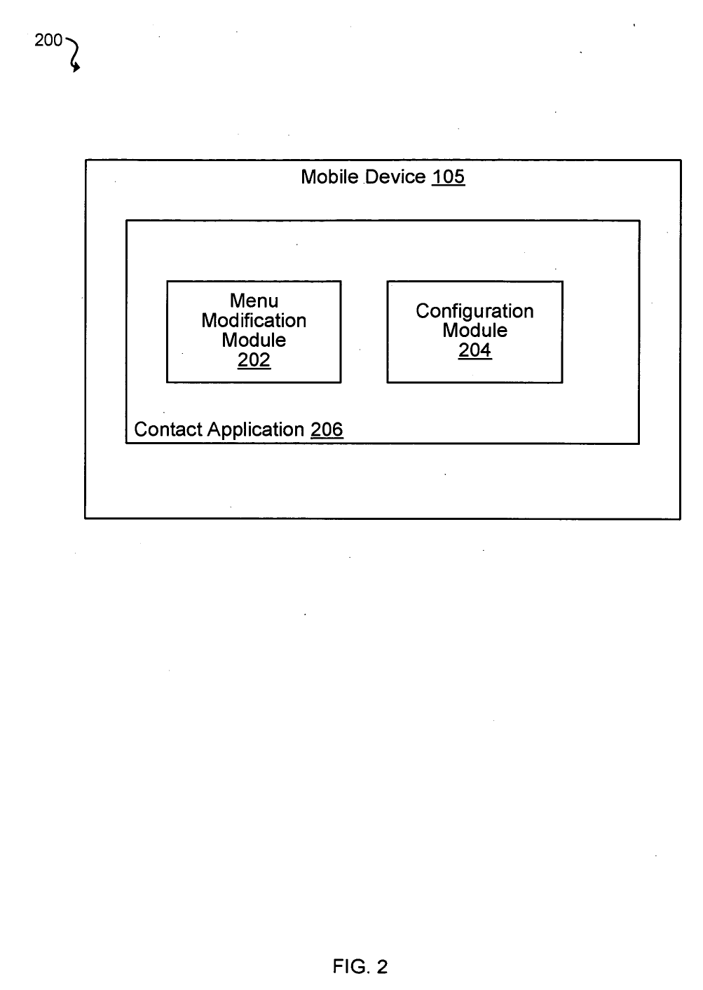

FIG. 2 is a block diagram of a mobile environment 200 showing a mobile device 105 (FIG. 1) configured with exemplary modules of an application for mobile device menu modification. The exemplary modules include menu modification module 202 and configuration module 204, which may reside on and/or interact with contact application 206. Once installed, the modified menu or menu enhancement will incorporate contact information that is found in a variety of places on the mobile device in such forms as a phone number in an email or in a text message (including the phone number of the text message sender), a phone number on a call log, a phone number in an address book, etc.

According to various exemplary embodiments, menu modification module 202 is configured to add a menu selection to contact application 206 for selecting a recipient to receive a bubble message. Configuration module 204 is configured to receive a selected recipient's telephone number or other similar information and to facilitate communication with bubble server 125. One or both of the modules may be received by the mobile device 105 in a variety of ways. For example, the modules or a link to the modules may be sent to the mobile device 105 by way of an email message or text message. A user may then load one or more of the modules on to the mobile device 105.

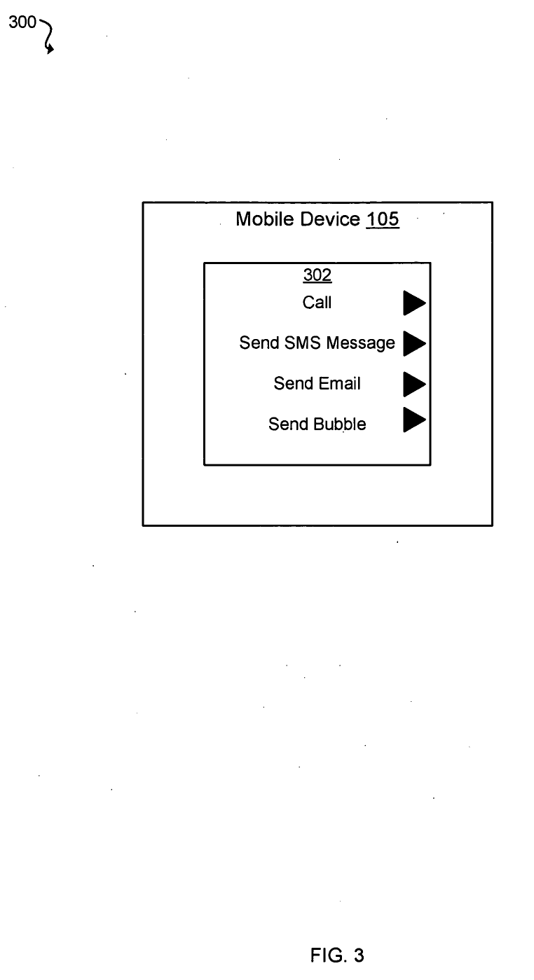

FIG. 3 is a block diagram of a mobile environment 300 showing an exemplary modified menu 302 of a contact application 206 (FIG. 2) on a mobile device 105 (FIG. 1). The exemplary modified menu 302 may be used for selecting a recipient to receive a bubble message from the mobile device 105.

In various exemplary embodiments, the contact application 206 of the mobile device 105 is opened, a contact list is displayed, and a recipient is selected to receive a bubble message. In general, prior to menu modification, a menu associated with the contact application 206 of a mobile device would be limited to offering selections for placing an ordinary telephone call, sending an ordinary SMS message, and/or sending an ordinary email. As illustrated in FIG. 3, the exemplary menu modification module 202 (FIG. 2) has added a new “Send Bubble” menu selection for display by the mobile device 105, along with the standard menu selections. The new “Send Bubble” provides for sending a bubble message, which may be a voice SMS message that may also include multimedia content. Multimedia content may be sourced from the bubble server 125.

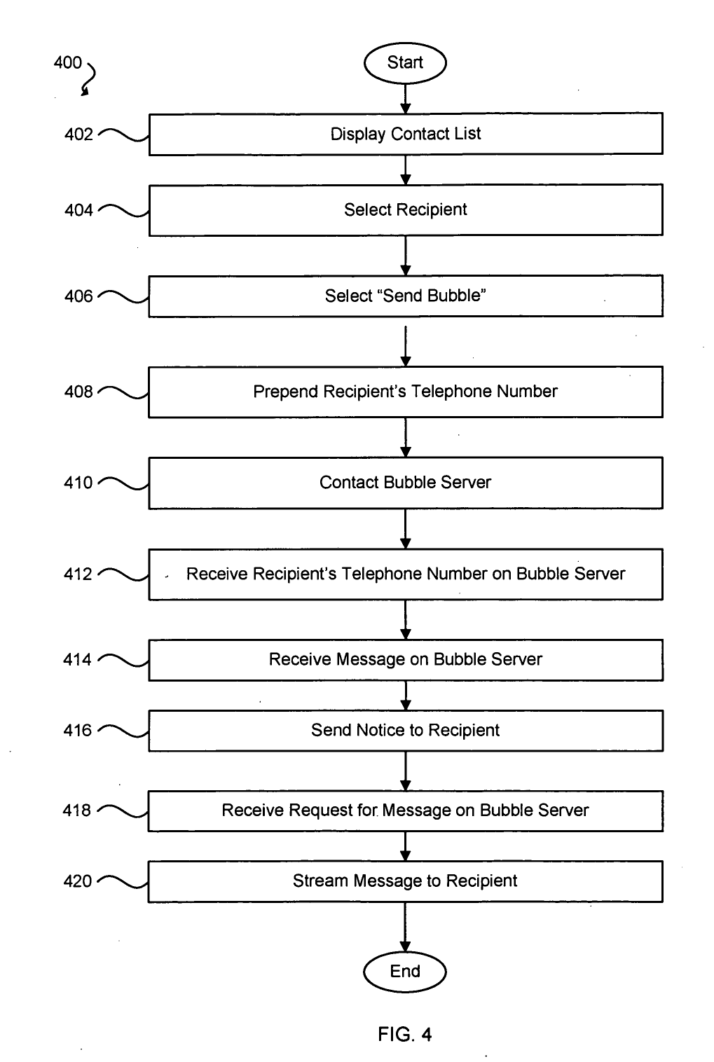

FIG. 4 is a flow chart illustrating an exemplary method 400 for using a modified menu 302 (FIG. 3) to select a recipient from a contact application 206 (FIG. 2) to receive a bubble message via a bubble server 125 (FIG. 1). The following method assumes the modified menu 302 has already been installed on mobile device 105 (FIG. 1).

At step 402, a contact list including the name (or other similar information) of a recipient is displayed, depending on the type of the contact application 206. Further, the recipient's telephone number may also be displayed.

At step 404, the recipient and/or associated information is selected.

At step 406, the exemplary modified menu 302 is displayed to provide a list of possible ways to communicate with the recipient. The menu selection of “Send Bubble” may be selected to send the recipient a bubble message. According to a further exemplary embodiment, the method automatically advances to step 408 herein.

At step 408, the recipient's telephone number is modified by the configuration module 204 (FIG. 2). According to one exemplary embodiment, a non-numeric (or numeric) character(s) is prepended to the recipient's telephone number. For example, the prepended character may be an asterisk (“*”). If the recipient's telephone number is 555-555-1212, after prepending with “*”, the resulting number dialed by the mobile device 105 would be *555-555-1212. In some embodiments, the prepended character may be another character, such as a pound sign (“#”). In other embodiments, the prepended character may be a character set. The prepended character or character set distinguishes the prepended portion from the recipient's telephone number. In some embodiments, the prepended character is prepended to all telephone numbers within the contact application 206.

According to an alternative embodiment, the recipient's telephone number is not prepended. Instead, the contact application 206 utilizes a telephone number for the bubble server 125 to contact the bubble server 125.

At step 410, the mobile device 105 contacts the bubble server 125. According to one exemplary embodiment, the prepended characters are utilized by a telecom service (e.g. telecom service 120 (FIG. 1)) to contact the bubble server 125. As described in connection with step 408 herein, according to an alternative embodiment, when the recipient's telephone number is not prepended, the contact application 206 may utilize a telephone number to contact the bubble server 125.

At step 412, the recipient's telephone number is received by the bubble server 125. In an exemplary embodiment, the recipient's telephone number is received as DTMF (Dual Tone Multi-Frequency) tones. In some embodiments, an originating telephone number (i.e. the sender's telephone number or other similar identifying information) is also received by the bubble server 125.

At step 414, the bubble server 125 receives a message from a sender intended for the recipient. The message may be received via the telecom service 120, and the message may be a SMS or SVMS message.

At step 416, a notice is sent to the recipient. The notice informs the recipient that a message from the sender is available for streaming to the recipient. The notice may appear in an “inbox” of the recipient's mobile device.

At step 418, a request for the bubble message is received by the bubble server 125 from the recipient.

At step 420, the bubble message is streamed to the recipient using the bubble server 125.

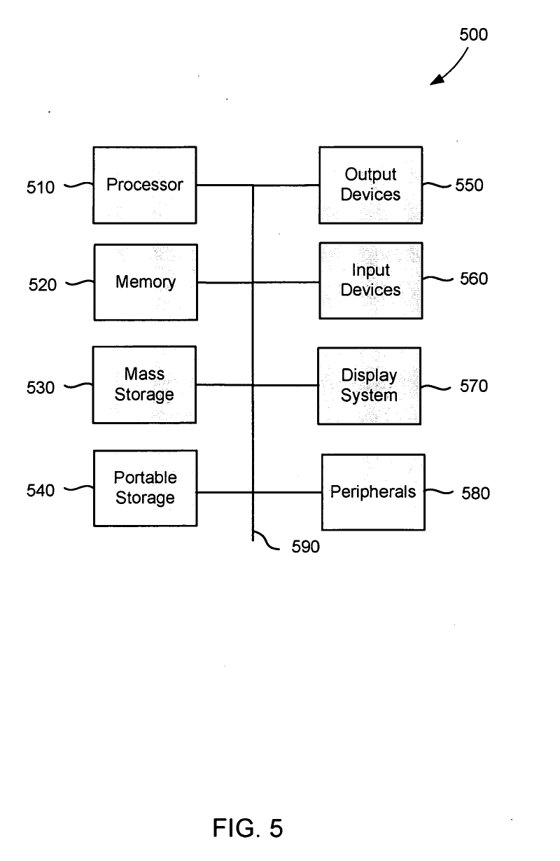

FIG. 5 is a block diagram of an exemplary computing device. In some embodiments, the exemplary computing device of FIG. 5 may be used to implement mobile device 105, telecom service 120, media distribution server 125, and telecom service 155 (as shown in FIG. 1).

FIG. 5 illustrates an exemplary computing system 500 that may be used to implement various embodiments of the present invention. The computing system 500 of FIG. 5 includes one or more processors 510 and memory 520. Memory 520 stores, in part, instructions and data for execution by processor 510. Memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. The components may be connected through one or more data transport means. Processor unit 510 and memory 520 may be connected via a local microprocessor bus, and the mass storage device 530, peripheral(s) 580, portable storage 540, and display system 570 may be connected via one or more input/output (I/O) buses.

Mass storage device 530, which may be implemented with a magnetic disk drive or an optical disk drive, is a non-volatile storage device for storing data and instructions for use by processor 510. Mass storage 530 can store the system software for implementing embodiments of the present invention for purposes of loading that software into memory 520.

Portable storage device 540 operates in conjunction with a portable non-volatile storage medium, such as a floppy disk, compact disk or digital video disc, to input and output data and code to and from the computer system 500 of FIG. 5. The system software for implementing embodiments of the present invention may be stored on such a portable medium and input to the computer system 500 via the portable storage 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. Peripheral device(s) 580 may include a modem or a router.

The components in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching.

What is claimed is:

1. A system for communicating with a bubble server, the system comprising:
a mobile device having a contact application;
a menu modification module communicatively coupled with the contact application, the menu modification module adding a menu selection to the contact application for selecting a recipient telephone number to receive a bubble message; and
a configuration module communicatively coupled with the contact application, the configuration module prepending the selected recipient telephone number for contacting the bubble server.

2. The system of claim 1, wherein the prepended selected recipient telephone number causes a telecom service to contact the bubble server.

3. The system of claim 1, wherein the selected recipient telephone number is received by the bubble server.

4. The system of claim 3, wherein the selected recipient telephone number is received by the bubble server in the form of DTMF tones.

5. The system of claim 1, wherein the bubble server receives a bubble message from the mobile device.

6. The system of claim 1, wherein the added menu selection is displayed on a display device of the mobile device.

7. The system of claim 6, wherein the added menu selection is displayed on the display device in addition to a displayed menu selection for placing a call on the mobile device.

8. The system of claim 6, wherein the added menu selection is displayed on the display device in addition to a displayed menu selection for sending an email with the mobile device.

9. The system of claim 6, wherein the added menu selection is displayed on the display device in addition to a displayed menu selection for sending an SMS message with the mobile device.

10. A method for utilizing a modified menu on a mobile device, the method comprising:
receiving a recipient telephone number;
prepending a non-numeric character to the recipient telephone number;
invoking a calling application to connect to a wireless carrier;
sending the non-numeric character to the wireless carrier;
sending the recipient telephone number to the wireless carrier;
connecting to a bubble server; and
sending DTMF tones of the recipient telephone number to the bubble server.

11. The method of claim 10, wherein the prepended recipient telephone number causes a telecom service to contact the bubble server.

12. The method of claim 10, wherein the recipient telephone number is received by the bubble server.

13. The method of claim 12, wherein the recipient telephone number is received by the bubble server in the form of DTMF tones.

14. The method of claim 10, wherein the bubble server receives a bubble message from the mobile device.

15. The method of claim 10, wherein an added menu selection is displayed on a display device of the mobile device.

16. The method of claim 15, wherein the added menu selection is displayed on the display device in addition to a displayed menu selection for placing a call on the mobile device.

17. The system of claim 15, wherein the added menu selection is displayed on the display device in addition to a displayed menu selection for sending an email with the mobile device.

18. The method of claim 15, wherein the added menu selection is displayed on the display device in addition to a displayed menu selection for sending an SMS message with the mobile device.

19. A computer readable storage medium having embodied thereon a program being executable by a processor to perform a method for utilizing a modified mobile device menu, the method comprising:
receiving a recipient telephone number;
prepending a non-numeric character to the recipient telephone number;
invoking a calling application to connect to a wireless carrier;
sending the non-numeric character to the wireless carrier;
sending the recipient telephone number to the wireless carrier;
connecting to a bubble server; and
sending DTMF tones of the recipient telephone number to the bubble server.
